(19) United States
(12) Patent Application Publication
(10) Pub. No.: US 2014/0192880 A1
(43) Pub. Date: Jul. 10, 2014

(54) INTER LAYER MOTION DATA INHERITANCE

(71) Applicants: Zhipin Deng, Beijing (CN); Yi-Jen Chiu, San Jose, CA (US); Lidong Xu, Beijing (CN); Wenhao Zhang, Beijing (CN); Yu Han, Beijing (CN); Xiaoxia Cai, Beijing (CN); Hong Jiang, El Dorado Hills, CA (US)

(72) Inventors: Zhipin Deng, Beijing (CN); Yi-Jen Chiu, San Jose, CA (US); Lidong Xu, Beijing (CN); Wenhao Zhang, Beijing (CN); Yu Han, Beijing (CN); Xiaoxia Cai, Beijing (CN); Hong Jiang, El Dorado Hills, CA (US)

(21) Appl. No.: 13/793,059

(22) Filed: Mar. 11, 2013

Related U.S. Application Data
(60) Provisional application No. 61/748,872, filed on Jan. 4, 2013.

(51) Int. Cl. H04N 7/26

(52) U.S. Cl. CPC H04N 19/00733
USPC 375/240.16

(57) ABSTRACT

Systems, devices and methods related to video coding including inter layer motion data inheritance are described.

### RELATED APPLICATIONS

The present application claims the benefit of U.S. Provisional Application No. 61/748,872 filed Jan. 4, 2013, and titled “INTER LAYER MOTION DATA INHERITANCE”.

### BACKGROUND

A video encoder compresses video information so that more information can be sent over a given bandwidth. The compressed signal may then be transmitted to a receiver that decodes or decompresses the signal prior to display.

High Efficiency Video Coding (HEVC), currently under development by the Joint Collaborative Team on Video Coding (JCT-VC) formed by ISO/IEC Moving Picture Expert Group (MPEG) and ITU-T Video Coding Experts Group (VCEG), is a video compression standard projected expected to be finalized in 2013. Similar to previous video coding standards, HEVC includes basic functional modules such as intra/inter prediction, transform, quantization, in-loop filtering, and entropy coding. HEVC defines a Largest Coding Unit (LCU) for a picture that is then partitioned into Coding Units (CUs) that take the form of rectangular blocks having variable sizes. Within each LCU, a quad-tree based splitting scheme specifies the CU partition pattern. HECV also defines Prediction Units (PUs) and Transform Units (TUs) that specify how a given CU is to be partitioned for prediction and transform purposes, respectively. A CU ordinarily includes one luma Coding Block (CB) and two chroma CBs together with associated syntax, and a PU may be further divided into Prediction Blocks (PBs) ranging in size from 64×64 samples down to 4×4 samples. After intra or inter prediction, transform operations are applied to residual blocks to generate coefficients. The coefficients are then quantized, scanned into one-dimensional order and, finally, entropy encoded.

HEVC is also expected to include a Scalable Video Coding (SVC) extension. An HEVC SVC bit stream includes several subset bit streams representing the source video content at different spatial resolutions, frame rates, quality, bit depth, and so forth. Scalability is then achieved using a multi-layer coding structure that, in general, includes a Base Layer (BL) and at least one Enhancement Layer (EL). This permits a picture, or portions of a picture such as a PU, belonging to an EL to be predicted from lower layer pictures (e.g., a BL picture) or from previously coded pictures in the same layer.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video coding system;

FIG. 2 is an illustrative diagram of an example video encoding system;

FIG. 3 is an illustrative diagram of an example video decoding system

FIG. 4 is a flow diagram illustrating an example process;

FIG. 5 is an illustrative diagram of an example system;

FIG. 6 is an illustrative diagram of an example coding scheme;

FIG. 7 is an illustrative diagram of an example bit stream;

FIG. 8 is a flow diagram illustrating an example process;

FIG. 9 is an illustrative diagram of an example system; and

FIG. 10 illustrates an example device;

FIG. 11 is a flow chart illustrating an example video coding process;

FIG. 12 is an illustrative diagram of an example video coding process in operation; and

FIG. 13 is an illustrative diagram of an example video coding system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Scalable video coding systems, apparatus, articles, and methods are described below. In scalable video coding systems, multi-layered coding is used to support several kinds of scalability including spatial scalability, temporal scalability, quality scalability, bit-depth scalability and so forth. In accordance with the present disclosure, various inter-layer motion data inheritance schemes may be used to increase scalable video coding efficiency and/or flexibility in scalable video coding systems. In various implementations inter-layer motion data inheritance may be employed by one or more of a video codec, a video encoder, a video processor, a media processor, or the like to enable, for example, inter-layer prediction in scalable video coding.

Systems, apparatus, articles, and methods are described below related to video coding including inter layer motion data inheritance.

As described above, High Efficiency Video Coding (HEVC) is expected to include a Scalable Video Coding (SVC) extension. An HECV SVC bit stream may include several subset bit streams representing the source video content at different spatial resolutions, frame rates, qualities, bit depths, and so forth. Scalability may then be achieved using a multi-layer coding structure that, in general, includes a base layer (BL) and at least one enhancement layer (EL), which may permit a picture, or portions of a picture such as a prediction unit (PU), belonging to an EL to be predicted from lower layer pictures (e.g., a BL picture) or from previously coded pictures in the same layer. Such techniques may cope with the heterogeneity of networks and devices in modem video service environments. For example, a SVC bit stream may contain several subset bit streams that may themselves be decoded such that the sub-streams may represent the source video content with different resolutions, frame rates, qualities, bit depths, and so forth. In various network and device scenarios, therefore, different video qualities may be achieved based on bandwidth or device constraints, for example.

As will be described in greater detail below, motion data may be determined at a reference layer (i.e., a base layer or lower level enhancement layer) of video data via a video coder (e.g., an encoder or decoder). Based on, or based in part on, the motion data, motion compensation may be performed at an enhancement layer (i.e., any enhancement layer at a higher layer than the reference layer). Thereby, motion compensation at the enhancement layer may be simplified and computing resources may be saved. In some examples, the motion compensation may be performed at an encoder and a bit stream may be encoded based in part on the motion compensation at the enhancement layer. In other examples, the motion compensation may be performed at a decoder and an enhancement layer output frame may be generated based in part on the motion compensation at the enhancement layer for presentment via a display device, for example.

As used herein, the term “coder” may refer to an encoder and/or a decoder. Similarly, as used herein, the term “coding” may refer to performing video encoding via an encoder and/or performing video decoding via a decoder. For example a video encoder and video decoder may both be examples of coders capable of coding video data. In addition, as used herein, the term “codec” may refer to any process, program or set of operations, such as, for example, any combination of software, firmware, and/or hardware, that may implement an encoder and/or a decoder. Further, as used herein, the phrase “motion data” may refer to any type of data associated with inter prediction including, but not limited to, one or more motion vectors, reference indices, and/or inter directions.

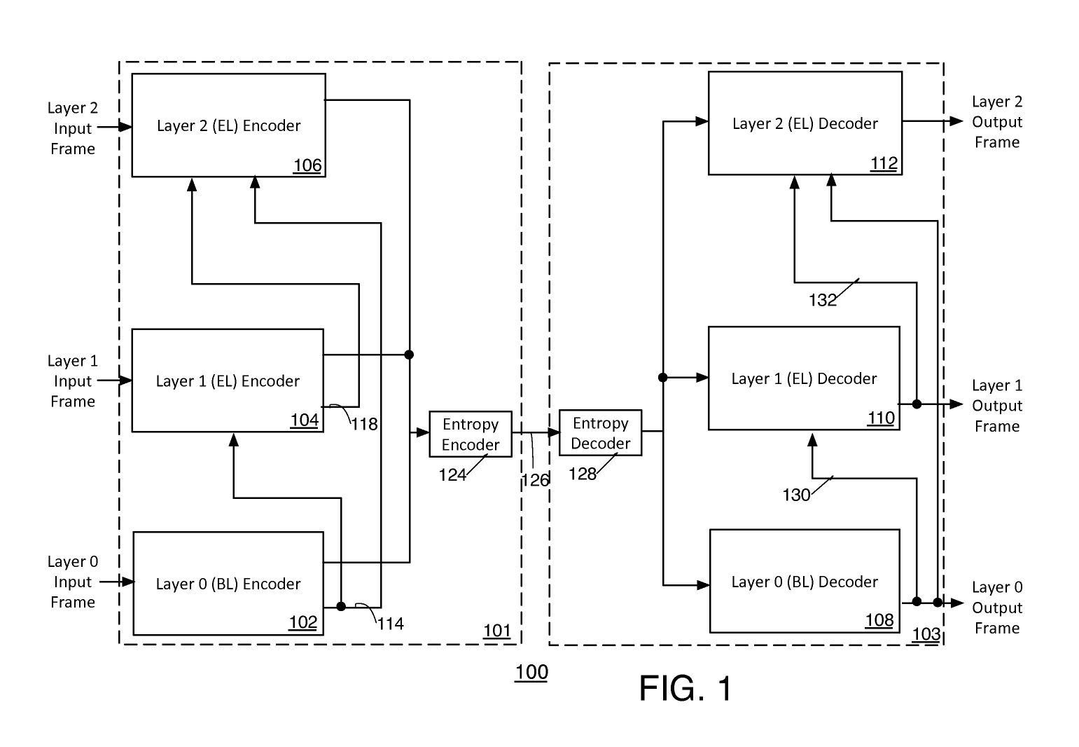

FIG. 1 illustrates an example scalable video coding (SVC) coding system 100, arranged in accordance with at least some implementations of the present disclosure. In general, system 100 may provide a computer implemented method for performing scalable video coding. In various implementations, system 100 may undertake video compression and decompression and/or implement video codecs according to one or more standards or specifications, such as, for example, the High Efficiency Video Coding (HEVC) standard (see ISO/IEC JTC/SC29/WG11 and ITU-T SG16 WP3, “High efficiency video coding (HEVC) text specification draft 8” (JCTVC-J1003_d7), July 2012) and any Scalable Video Coding (SVC) extension of thereof. Although system 100 and/or other systems, schemes or processes may be described herein in the context of an SVC extension of the HEVC standard, the present disclosure is not limited to any particular video encoding standard or specification or extensions thereof.

The HEVC standard specifies a Largest Coding Unit (LCU) for a picture that may then be partitioned into Coding Units (CUs) that take the form of rectangular blocks having variable sizes. Within each LCU, a quad-tree based splitting scheme may specify the CU partition pattern. HECV also defines Prediction Units (PUs) and Transform Units (TUs) that may specify how a given CU is to be partitioned for prediction and transform purposes, respectively. A CU may generally include one luma Coding Block (CB) and two chroma CBs together with associated syntax, and a PU may be further divided into Prediction Blocks (PBs) ranging in size from 64×64 samples down to 4×4 samples. As used herein, the term “block” may refer to any partition or sub-partition of a video picture. For example, a block may refer to a PU, a PB, a TU, a CU, or a CB, or the like.

As illustrated, system 100 may include an encoder subsystem 101 that may have multiple video encoders including a Layer 0 or base layer (BL) encoder 102, a Layer 1 or first enhancement layer (EL) encoder 104, and a Layer 2 or second EL encoder 106. System 100 may also include corresponding video decoders of a decoder subsystem 103 including a Layer 0 (BL) decoder 108, a Layer 1 (EL) decoder 110, and a Layer 2 (EL) decoder 112. In general, the BL may be HEVC compatible coded. When coding an EL with a layer identification (ID) equal to N, for example, SVC coding schemes provide all coding layers having a layer ID less than N for use in inter-layer prediction schemes so that a picture belonging to a particular EL may be predicted from lower layer pictures (e.g., in a BL or one or more lower layer ELs) or from previously coded pictures in the same EL.

In accordance with the present disclosure, as will be explained in greater detail below, either or both of EL encoders 104 and 106 may use motion data such as, but not limited to, one or more motion vectors, reference indices, and/or inter directions obtained from either encoder 102 or 104 to perform motion compensation. For example, in some implementations, encoder 104 may perform motion compensation using, at least in part, motion data 114 obtained from encoder 102. In addition, in some implementations, encoder 106 may perform motion compensation using, at least in part, motion data 114 and/or motion data 118 obtained, respectively, from encoder 102 and/or encoder 104.

As used herein the term “inter-layer prediction” refers to performing motion compensation while undertaking inter prediction for a portion of an EL block, such as a Prediction Unit (PU), using, at least in part, motion data associated with one or more corresponding blocks of a lower layer picture (e.g., one or more PUs of a BL or a lower EL layer picture). The use of inherited motion data in EL inter prediction may improve the compression efficiency and coding flexibility of an SVC system, such as system 100, by permitting a coding system to reuse motion data in lieu of providing separate motion data for various EL blocks. In various implementations in accordance with the present disclosure, inter-layer prediction may be applied in any combination of temporal, spatial, bit depth, and/or quality scalable video coding applications.

As discussed, an EL may use inherited motion data to perform motion compensation. Also as discussed, the motion data may be received at the EL from a BL or a lower level EL (or both). As used herein the term “reference layer” (RL) refers to either a BL or an EL that may provide the motion data to the EL receiving and using the motion data to perform motion compensation. In general, the EL receiving and using the motion data to perform motion compensation may be considered a “target EL” or simply an EL.

Employing any one or more of encoders 102, 104 and 106, encoder subsystem 101 may provide separate bit streams to an entropy encoder 124. Entropy encoder 124 may then provide a compressed bit stream 126, including multiple layers of scalable video content, to an entropy decoder 128 of decoder subsystem 103. In accordance with the present disclosure, as will also be explained in greater detail below, either or both of EL decoders 110 and 112 may use motion data obtained from either decoder 108 or 110 to perform inter prediction when decoding video data. For example, in some implementations, decoder 110 may perform motion compensation using motion data 130 obtained from decoder 108. In addition, in some implementations, decoder 112 may perform motion compensation using motion data 130 and/or motion data 132 obtained, respectively, from either or both of decoder 108 and/or decoder 110.

While FIG. 1 illustrates system 100 as employing three layers of scalable video content and corresponding sets of three encoders in subsystem 101 and three decoders in subsystem 103, any number of scalable video coding layers and corresponding encoders and decoders may be utilized in accordance with the present disclosure. Further, the present disclosure is not limited to the particular components illustrated in FIG. 1 and/or to the manner in which the various components of system 100 are arranged.

Further, it may be recognized that encoder subsystem 101 may be associated with and/or provided by a content provider system including, for example, a video content server system, and that bit stream 126 may be transmitted or conveyed to decoder subsystem 103 by various communications components and/or systems such as transceivers, antennae, network systems and the like not depicted in FIG. 1. It may also be recognized that decoder subsystem 103 may be associated with a client system such as a computing device (e.g., a desktop computer, laptop computer, tablet computer, mobile phone or the like) that receives bit stream 126 via various communications components and/or systems such as transceivers, antennae, network systems and the like not depicted in FIG. 1. Therefore, in various implementations, encoder subsystem 101 and decoder subsystem 103 may be implemented either together or independent of one another. Further, while systems, apparatus and methods described herein may refer to performing inter-layer prediction for a block such as a PU of an EL picture, the present disclosure is not limited in this regard and inter-layer prediction may be performed for any partition of an EL picture including, for example, for a PB sub-partition of a PU or any other block as discussed herein.

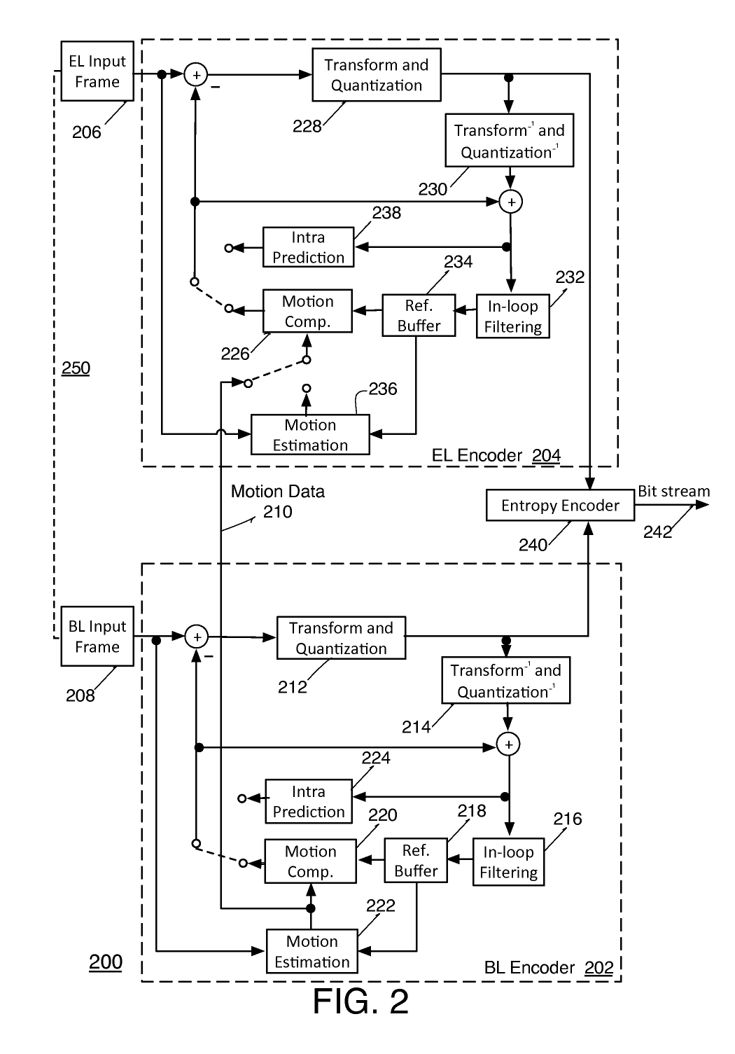

FIG. 2 illustrates an example SVC encoding system 200, arranged in accordance with at least some implementations of the present disclosure. As shown, system 200 may include a BL encoder 202 and an EL encoder 204 that may correspond, in an example, to encoder 102 and encoder 104, respectively, of system 100. While system 200 may include only two encoders 202 and 204 corresponding to two SVC coding layers, such as, for example, a base layer encoder and an enhancement layer encoder, any number of SVC coding layers and corresponding encoders may be utilized in accordance with the present disclosure in addition to those depicted in FIG. 2. For example, additional encoders corresponding to additional enhancement layers may be included in system 200 and may interact with encoder 202 in a similar manner to that to be described below with respect to encoder 204. For example, although described with respect to BL encoder 202 and EL encoder 204 for the sake of clarity of presentation, system 200 may include any reference layer encoder and enhancement layer encoder associated with a reference layer and enhancement layer as discussed herein. In general, a reference layer encoder may be an encoder for a base layer (as shown) or for any enhancement layer at a lower level than the enhancement layer associated with EL encoder 204.

As shown, BL encoder 202 may receive BL input frame 208 and EL encoder 204 may receive EL input frame 206. In general, input frame 208 may be associated with a BL of video data 250 and EL input frame 206 may be associated with an EL of the video data (such as a target EL). In other examples, video data 250 may include a reference layer and an enhancement layer as discussed.

When employing system 200 to undertake SVC coding, at least some blocks of EL input frame 206 may be predicted by EL encoder 204 from one or more blocks of BL input frame 208 as processed by BL encoder 202 or from other pictures in the same enhancement layer that were previously encoded by EL encoder 204. As will be described in greater detail below, when undertaking inter-layer prediction operations using system 200 one or more blocks of EL input frame 206 may be motion compensated using, at least in part, motion data 210 inherited from and provided by BL encoder 202. In various examples, motion data 210 may include one or more motion vectors, reference indices, and/or inter directions or the like. Further, the use of inherited motion data to perform EL motion compensation as described herein may be applied at a slice, picture, or layer level.

Motion data 210 may be determined based on the processing of BL input frame 208 using a coding loop that may include a transform and quantization module 212, an inverse transform and quantization module 214, an in-loop filtering module 216, a reference buffer 218, a motion compensation module 220, or a motion estimation module 222, or the like. As shown in FIG. 2, motion data 210 may be obtained from motion estimation module 222. In some examples, BL encoder 202 may also include an intra prediction module 224. The functionality of modules 212, 214, 216, 218, 220 and 224 are well recognized in the art and will not be described in any greater detail herein.

As shown, at EL encoder 204, motion data 210 provided by BL encoder 202 may be received at a motion compensation module 226 and may be used, at least in part, to perform motion compensation for blocks of EL input frame 206 using a coding loop that may include a transform and quantization module 228, an inverse transform and inverse quantization module 230, a reference buffer 234, or a motion compensation module 226, or the like. EL encoder 204 may also include an intra prediction module 238. The functionality of modules 228, 230, 233, and 234 are well recognized in the art and will not be described in any greater detail herein. As shown, in accordance with the present disclosure, EL encoder 204 may use motion data 210 to perform motion compensation for blocks of EL input frame 206. For example, EL encoder 204 may use motion data 210 rather than employing motion estimation module 236 to perform motion compensation for blocks of EL input frame 206. For example, EL encoder 204 may perform motion compensation at motion compensation module 226 for a block of an enhancement layer of video data 250 based at least in part on motion data 210. As will be appreciated, the motion compensation may be performed any number of blocks of an number of EL input frames (such as EL input frame 206).

In various implementations either or both of BL encoder 202 and EL encoder 204 may provide compressed coefficients corresponding to coded residuals of at least some of BL input frame 208 and of at least some of EL input frame 206, respectively, to an entropy encoder module 240. Entropy encoder module 240 may perform lossless compression (e.g., via Context-adaptive binary arithmetic coding (CABAC)) of the residuals and provide a multiplexed SVC bit stream 242 including the encoded residuals as output from system 200. Further, as will be described in greater detail below, bit stream 242 may include an indicator, such as a flag, that specifies whether or not to use inherited motion data to perform motion compensation for a given EL block. As will be described in greater detail below, depending on the value of such an indicator, a decoding system may or may not perform inter-layer prediction using inherited motion data as described herein. Further, and as will also be described in greater detail below, bit stream 242 may include a scaling factor associated with a spatial scalability between the base layer (e.g., reference layer) and the enhancement layer. Depending on the value of such a scaling factor, a decoding system may scale motion data (e.g., motion vectors or the like) to compensate for the spatial scalability.

As discussed, motion data 210 associated with a reference layer (in the illustrated example, a base layer) of video data 250 may be determined and motion compensation for a block of an enhancement layer of video data 250 may be performed based at least in part on motion data 210. As is discussed further herein, in some examples, in order to determine motion data 210, a collocated block of the reference layer associated with the block of the enhancement layer may be determined. In some examples, a spatial scalability between the reference layer and the enhancement layer is enabled and the enhancement layer picture size may be greater than the reference layer picture size such that determining the collocated block may include using at least one of a top-left location, a center location, or a bottom right location of the block of the enhancement layer to determine the collocated block. Further, prior to performing the motion compensation, motion data 210 may be scaled by applying a scaling factor to one or more motion vectors of motion data 210. The scaling factor may be pre-defined or adaptive, as is discussed further herein. Further, as shown, bit stream 242 may be encoded based at least in part on the performed motion compensation.

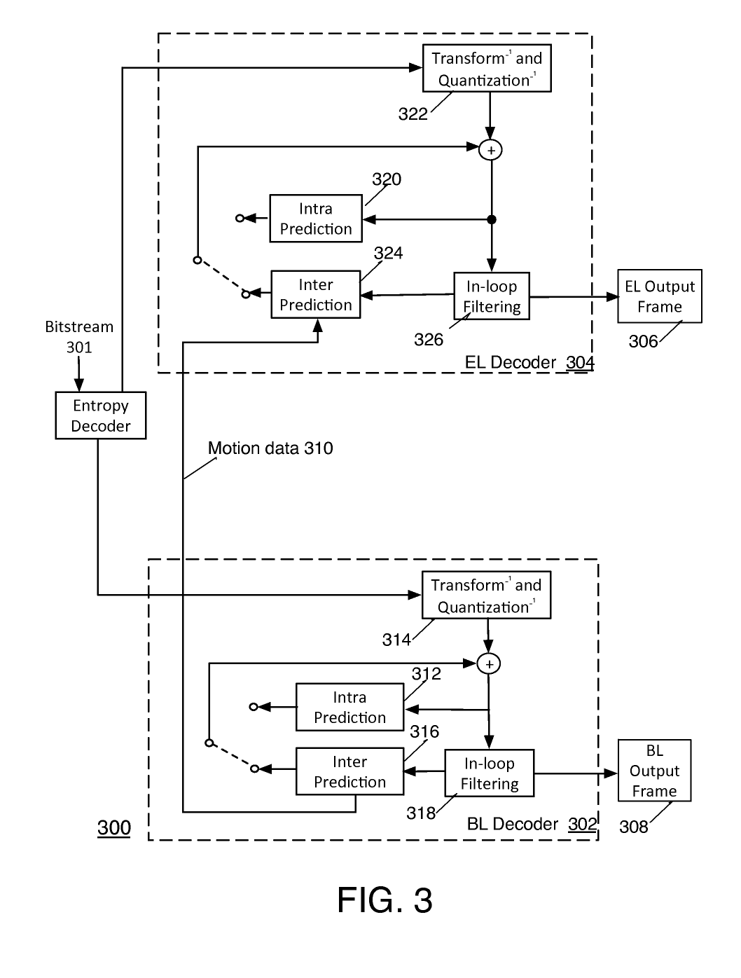

FIG. 3 illustrates an example SVC decoding system 300, arranged in accordance with at least some implementations of the present disclosure. System 300 includes a BL decoder 302 and a target EL decoder 304 that may correspond, for example, to decoder 108 and decoder 110, respectively, of system 100. While system 300 includes only two decoders 302 and 304 corresponding to two SVC coding layers, any number of SVC coding layers and corresponding decoders may be utilized in accordance with the present disclosure in addition to those depicted in FIG. 3. For example, additional decoders corresponding to additional enhancement layers may be included in system 300 and may interact with the BL decoder 302 in a similar manner to that to be described below with respect to EL decoder 304. For example, although described with respect to BL decoder 302 and EL decoder 304 for the sake of clarity of presentation, system 300 may include any reference layer decoder and enhancement layer decoder associated with a reference layer and enhancement layer as discussed herein. In general, a reference layer decoder may be a decoder for a base layer (as shown) or for any enhancement layer at a lower level than the enhancement layer associated with EL decoder 304.

When employing system 300 to undertake SVC coding, various blocks in EL output frame 306 may be inter predicted by EL decoder 304 from blocks of BL output frame 308 as processed by BL decoder 302 or from other pictures in the same EL that were previously decoded by EL decoder 304. As will be described in greater detail below, such inter prediction of blocks in EL output frame 306 may employ motion data 310 provided by BL decoder 302. Motion data 310 may be obtained from an inter prediction module 316 (having, e.g., a motion estimation module) of BL decoder 302. BL decoder 302 may also include an inverse transform and quantization module 314, an intra prediction module 312, and/or an in-loop filtering module 318.

As will be described in greater detail below, motion data 310 may be provided to an inter prediction module 324 of EL decoder 304. EL decoder 304 may also include an inverse transform and quantization module 322, an intra prediction module 320, and an in-loop filtering module 326. When operated to undertake inter-layer prediction, EL decoder 304 may employ inter prediction module 324 (having, e.g., a motion compensation module) and inherited motion data 310 to reconstruct pixel data for various blocks of EL output frame 306. Further, EL decoder 304 may do so based on the value of an indicator provided in bit stream 301 where bit stream 301 may correspond to bit stream 126 of FIG. 1, bit stream 242 of FIG. 2, or the like. For example, bit stream 201 may include an indicator (e.g., a bit stream flag) specifying whether to perform the motion compensation or not. The bit stream may be accessed to determine the indicator and, if the indicator specifies that motion compensation is to be performed, inter prediction module 324 may perform motion compensation for a block of an enhancement layer of the video data based at least in part on motion data 310.

As discussed, motion data 310 associated with a reference layer (in the illustrated example, a base layer) of video data (i.e., video data associated with bit stream 301) may be determined and motion compensation for a block of an enhancement layer of the video data may be performed based at least in part on motion data 310. As is discussed further herein, in some examples, in order to determine motion data 310, a collocated block of the reference layer associated with the block of the enhancement layer may be determined. In some examples, a spatial scalability between the reference layer and the enhancement layer is enabled and the enhancement layer picture size may be greater than the reference layer picture size such that determining the collocated block may include using at least one of a top-left location, a center location, or a bottom right location of the block of the enhancement layer to determine the collocated block. Further, prior to performing the motion compensation, motion data 310 may be scaled by applying a scaling factor to one or more motion vectors of motion data 310. The scaling factor may be pre-defined or adaptive, as is discussed further herein. In some examples, the scaling factor may be included in bit stream 301. In other examples, the scaling factor may be determined by system 300. Further, as shown, EL output frame 306 may be generated based at least in part on the motion compensation.

Various components of the systems described herein may be implemented in software, firmware, and/or hardware and/or any combination thereof. For example, various components of system 300 may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, systems 100, 200 and 300 may include additional components such as bit stream multiplexer or de-multiplexer modules and the like that have not been depicted in FIGS. 1, 2 and 3 in the interest of clarity.

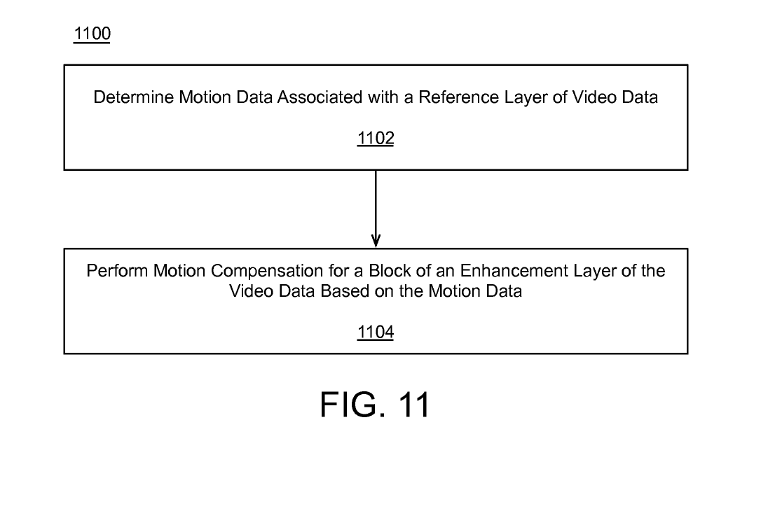

FIG. 11 is a flow chart illustrating an example video coding process 1100, arranged in accordance with at least some implementations of the present disclosure. In the illustrated implementation, process 1100 may include one or more operations, functions or actions as illustrated by one or more of blocks 1102 and/or 1104. By way of non-limiting example, process 1100 will be described herein with reference to example video coding system 200 or video coding system 200. Although process 1100, as illustrated, is directed to encoding, the concepts and/or operations described may be applied in the same or similar manner to coding in general, including in decoding.

Process 1100 may be utilized as a computer-implemented method for performing scalable video coding. Process 1100 may begin at operation 1102, “DETERMINE MOTION DATA ASSOCIATED WITH A REFERENCE LAYER OF VIDEO DATA”, where motion data associated with a reference layer of video data may be determined. For example, motion data 210 may be determined at BL encoder 202 or motion data 310 may be determined a BL decoder 302. As discussed, the motion data may include, for example, one or more motion vectors, reference indices, and/or inter directions. Also as discussed, the reference layer may be a base layer or an enhancement layer that is at a lower level than the target enhancement layer (i.e., the enhancement layer to which the motion data will be transferred).

Processing may continue from operation 1102 to operation 1104, “PERFORM MOTION COMPENSATION FOR A BLOCK OF AN ENHANCEMENT LAYER OF THE VIDEO DATA BASED AT LEAST IN PART ON THE MOTION DATA”, where motion compensation for a block of an enhancement layer of the video data may be performed based at least in part on the motion data. For example, EL encoder 204 may perform motion compensation based at least in part on motion data 210 or EL decoder 304 may perform motion compensation based at least in part on motion data 310. As is discussed further herein, a collocated block of the reference layer may be determined such that the collocated block is associated with the block of the enhancement layer. As is also discussed further herein, a scaling factor may be applied to the motion data prior to performing the motion compensation.

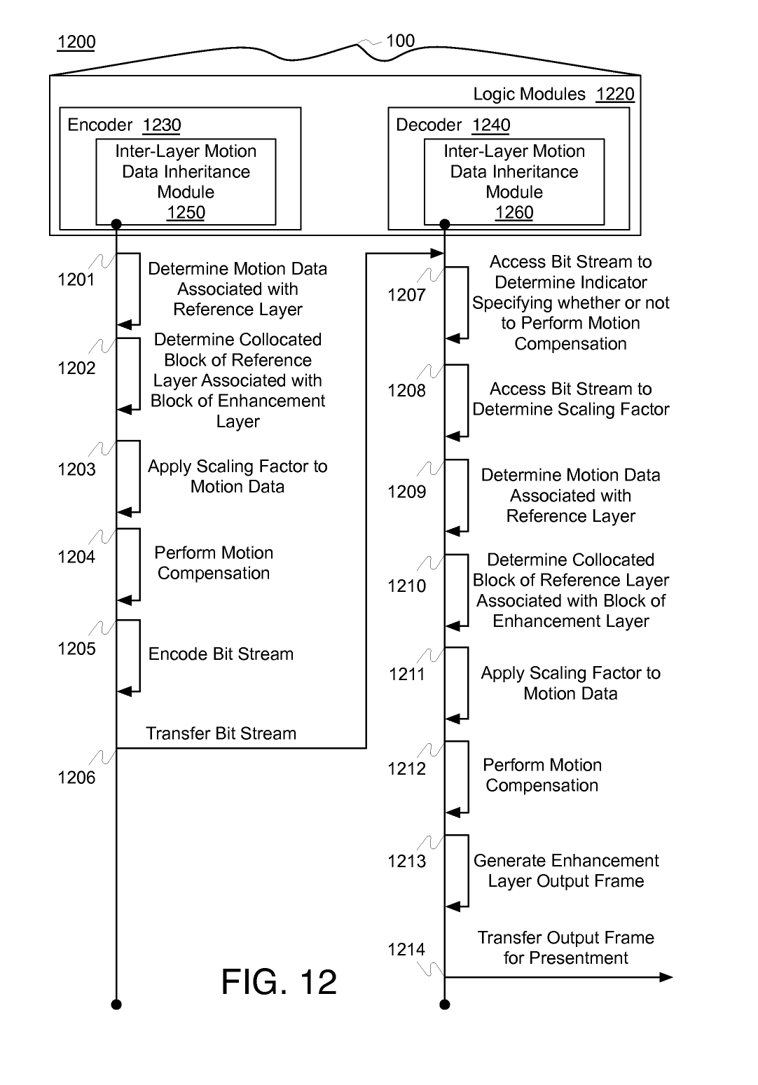

In general, process 1100 may be repeated any number of times either serially or in parallel for any number of blocks of the enhancement layer and/or for any number of frames of data, or the like. The resultant motion compensation may be used to encode a bitstream or generate an enhancement layer frame or frames for presentment via a display device, for example. Some additional and/or alternative details related to process 1100 may be illustrated in one or more examples of implementations discussed herein and, in particular, with respect to FIG. 12 below.

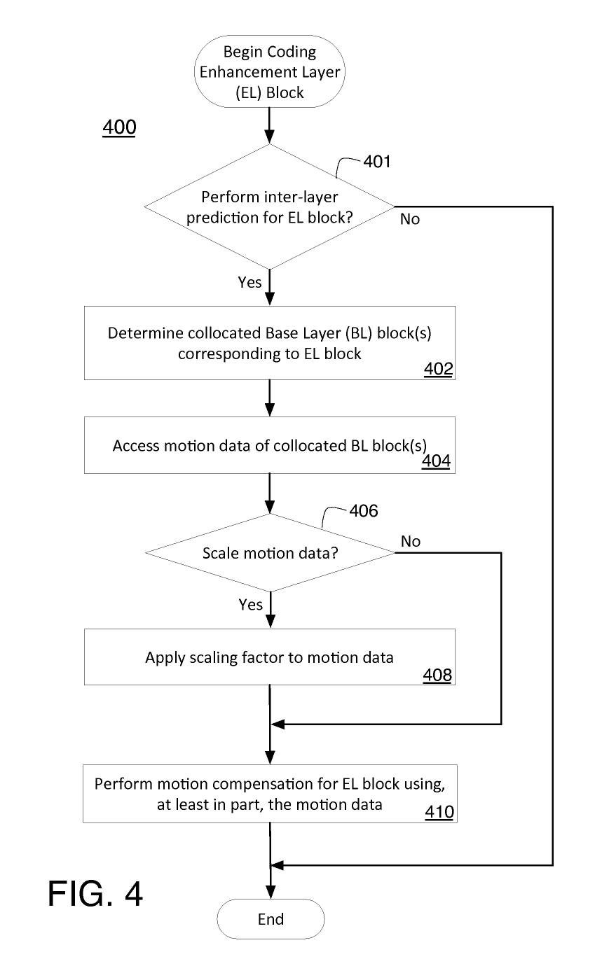

FIG. 4 illustrates a flow diagram illustrating an example process 400, arranged in accordance with at least some implementations of the present disclosure. Process 400 may include one or more operations, functions or actions as illustrated by one or more of blocks 401, 402, 404, 406, 408, and 410 of FIG. 4. Process 400 may form at least part of a scalable video coding process. By way of non-limiting example, process 400 may form at least part of a scalable video decoding process for one or more EL layer blocks as undertaken by decoder system 300 of FIG. 3 although process 400 or portions thereof may be undertaken to form at least part of a scalable video encoding process as discussed herein.

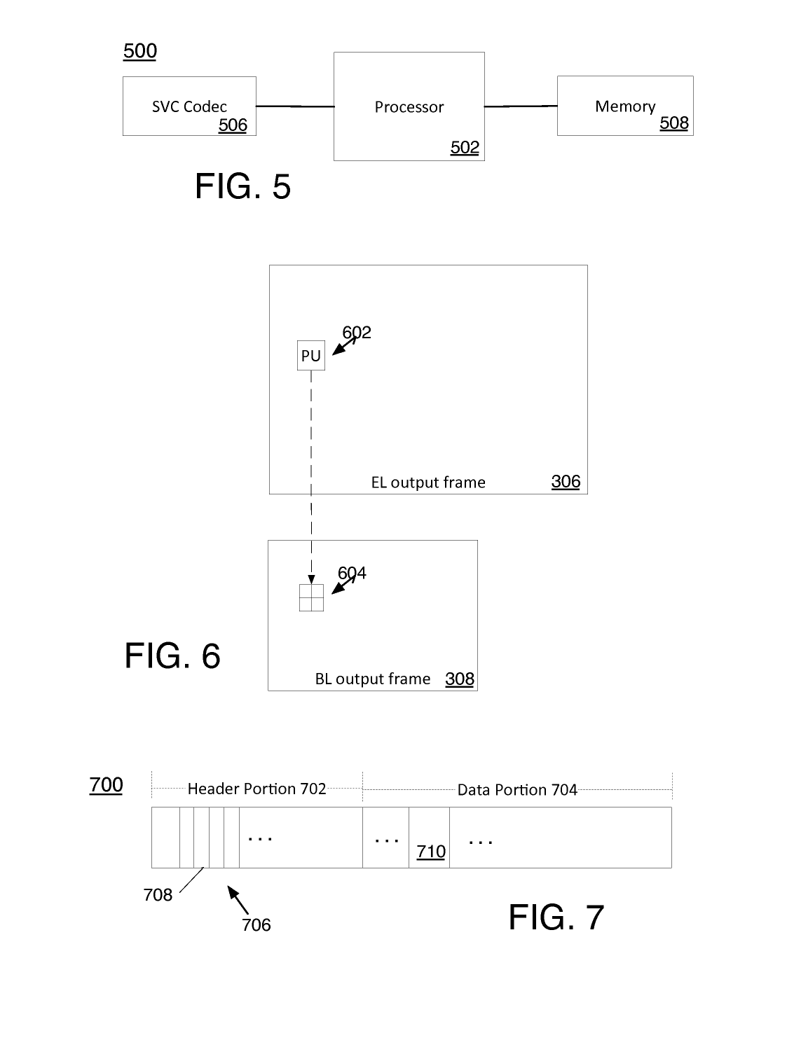

Further, process 400 will be described herein in reference to coding an EL PU using the scalable video coding system 500 of FIG. 5. FIG. 5 is an illustrative diagram of an example system 500, arranged in accordance with at least some implementations of the present disclosure. As shown in FIG. 5, system 500 may include processor 502, SVC codec module 506, and memory 508. Processor 502 may instantiate SVC codec module 506 to provide for inter-layer prediction in accordance with the present disclosure. In the example of system 500, memory 508 may store video content including at least some of BL output frame 308 and/or at least some of EL output frame 306, as well as other items such as motion data (including motion vectors, reference indices, and/or inter directions) as will be explained in greater detail below. SVC codec module 506 may be provided by any combination of software, firmware, and/or hardware. As is discussed further herein, in some examples SVC codec module 506 or, more generally, a logic module, may include an inter-layer motion data inheritance module, which may be configured to determine motion data associated with a reference layer of video data and perform motion compensation for a block of an enhancement layer of the video data based at least in part on the motion data, for example. Memory 508 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 508 may be implemented by cache memory.

Returning to discussion of FIG. 4, process 400 may begin at decision block 401, “Perform inter-layer prediction for EL block?”, where a determination may be made regarding whether inter-layer prediction should be performed for a current EL block. If inter-layer prediction is to be performed then process 400 may continue at block 402, if, however, inter-layer prediction is not to be performed, then process 400 may end. In some examples, such as decoder implementations, determining whether inter-layer prediction is to be performed may include accessing a bit stream to determine an indicator (e.g., a bit stream flag) such that the indicator specifies whether to perform the motion compensation.

Process 400 may continue at block 402, “Determine collocated Base Layer (BL) block(s) corresponding to EL block”, where, for a current EL block, one or more collocated blocks of a BL corresponding to the EL block may be determined. For example, FIG. 6 is an illustrative diagram of an example coding scheme, arranged in accordance with at least some implementations of the present disclosure. FIG. 6 illustrates a current block (in this example a PU) 602 of EL output frame 306 where PU 602 corresponds spatially to more than one collocated block of BL output frame 308. In this example, PU 602 corresponds to four collocated blocks 604 of BL output frame 308. However, in various implementations, depending on the spatial scaling between an EL and a BL or lower level EL, any number of BL or lower level EL blocks may be collocated with respect to a particular EL PU. In other implementations, only a portion of a BL or lower level EL block may be collocated with an EL PU. As used herein, the term “collocated” refers to the spatial correlation between one or more blocks of an EL and a block of an EL layer and should be considered synonymous with the term “co-located”.

Further, in some scalable coding implementations where spatial scaling is not applied between the EL and lower EL or BL layers there may be a one-to-one correspondence spatially between blocks in an EL and blocks in a lower EL or in a BL. With respect to the example of FIG. 6, determining collocated blocks at block 402 may involve marking or otherwise labeling blocks 604 as being collocated with respect to the current PU 602.

In various implementations, where spatial scaling is applied so that the spatial ratio between an EL and a BL is greater than one, different locations of an EL block may be used to derive the collocated BL blocks. For instance, in various examples, a left-top location, a center location, or a right-bottom location of PU 602 may be used to determine collocated blocks 604 in BL output frame 308. In some examples, a spatial scalability between the reference layer and the enhancement layer may be enabled and enhancement layer picture size of the enhancement layer may be greater than a reference layer picture size of the reference layer. In such examples, determining the collocated block may include using one of a top-left location, a center location, or a bottom right location of the block of the enhancement layer to determine the collocated block of the reference layer.

Process 400 may continue at block 404, “Access motion data of collocated BL block(s)”, where motion data corresponding to the collocated block(s) may be accessed. For instance, referring to FIGS. 5 and 6, block 404 may involve SVC codec module 506 using processor 502 to obtain, from memory 508, motion data corresponding to one or more of collocated blocks 604. For instance, memory 508 may act as a frame buffer for temporarily storing video content such as the portions of BL output frame 308 as well as motion data associated with blocks 604.

In various examples, the motion data accessed or inherited at block 404 may include any combination of motion vectors, reference indices, and/or inter directions. In some examples all of the motion vectors, reference indices, and inter directions of the collocated BL blocks may be accessed or inherited; in other examples only the motion vectors of the BL blocks may be inherited; in yet other examples only reference indices and inter directions of the BL blocks may be inherited to the EL block; and so forth.

In some implementation collocated BL blocks may include all inter coded blocks. In other implementations, collocated BL blocks may include hybrid coded blocks such that some portions of the collocated BL blocks are inter coded, while other portions are intra coded. In such implementations, block 404 may involve specifying motion data for the intra coded portions of collocated BL blocks. For instance, intra coded portions of collocated BL blocks may be associated with motion data of neighboring inter coded portions such as left, top, top-right spatially neighboring portions or temporally collocated blocks. In other implementations, intra coded portions of collocated BL blocks may be associated with a motion vector equal to (0, 0), a reference index equal to 0, and/or an inter direction (uni-prediction or bi-prediction) equal to a slice type, or the like.

In some examples where collocated BL blocks are hybrid coded such that some portions of the collocated BL blocks are inter coded, while other portions are intra coded, block 404 may involve specifying compensated pixels for the intra coded portions of collocated BL blocks. For instance, intra coded portions of collocated BL blocks may be filled with reconstructed pixels of the inter-layer collocated blocks. And in the case of spatial scalability, the reconstructed pixels of the inter-layer blocks may be upsampled.

In various implementations, the motion data accessed or inherited at block 404 may be inherited with various granularities. For example, for a 16×16 PU, motion vectors may be inherited with granularities of 4×4, 8×8, or 16×16; while for an 8×16 PU, motion vectors may be inherited with granularities of 4×4, or 8×8; and so forth.

Process 400 may continue at decision block 406, “Scale motion data?”, where a determination may be made whether to scale the motion data accessed at block 404. If the determination is positive then process 400 may proceed to block 408, “Apply scaling factor to motion data”, where a scaling factor may be applied to the motion data. For instance, when spatial scaling applies such that the spatial ratio between the EL and BL is greater than one, one or more motion vectors accessed as block 404 may be upsampled at block 408 by applying a scaling factor that corresponds to the spatial ratio. In various implementations, an upsample scaling factor applied at block 408 may be a fixed scaling factor or may be an adaptive scaling factor. For a fixed scaling factor, the scaling factor may be pre-defined and used by both an encoder and a decoder. In implementations with adaptive scaling, the scaling factor may be trained at the encoder side and then communicated to a decoder in a bit stream. For example, referring to FIG. 1, encoder subsystem 101 may use bit stream 126 to communicate an adaptive scaling factor to decoder subsystem 103. A decoder may access the bit stream associated with the video data to determine the scaling factor, for example.

Process 400 may then conclude at block 410, “Perform motion compensation for EL block using, at least in part, the motion data”, where motion compensation for the EL block may be performed using, at least in part, the motion data accessed at block 404 and, if need be, upsampled or scaled at block 408. In various implementations, block 410 may, for example, involve using a motion vector inherited from a collocated BL block to motion compensate the EL block. For example, motion compensation for a block of an enhancement layer of video data may be performed based at least in part on the motion data. In general, the motion data may include a motion vector, a reference index, or an inter direction, or the like.

As discussed, in various implementations, when reference pictures of the collocated BL block(s) are different from the reference pictures of the EL block, the motion vectors of collocated BL blocks accessed at block 404 may be additionally scaled to align with the reference pictures of the EL block(s). For example, fixed or adaptive scaling factors may be applied. For fixed scaling factors, this additional scaling factor may be pre-defined and used by both an encoder and a decoder. For adaptive scaling factors, the additional scaling factor may be trained at the encoder side and sent to decoder in a bit stream.

As discussed, in various implementations, portions of process 400, such as the determination of whether to perform inter-layer prediction at block 401, may be undertaken in response to an indication provided to a decoder in, for instance, a bit stream. For example, FIG. 7 is an illustrative diagram of an example bit stream 700, such as bit streams 126, 242, or 301, arranged in accordance with at least some implementations of the present disclosure. As shown in FIG. 7, bit stream 700 may include a header portion 702 and a data portion 704. Header portion 702 may include one or more indicators 706. For example, indicators 706 may include an indicator or flag 708 whose value specifies whether or not to perform inter-layer prediction using inherited motion data, as described herein, for a current block of an EL. In addition, bit stream 700 may include other information such as one or more adaptive scaling factor(s) 710 as described above.

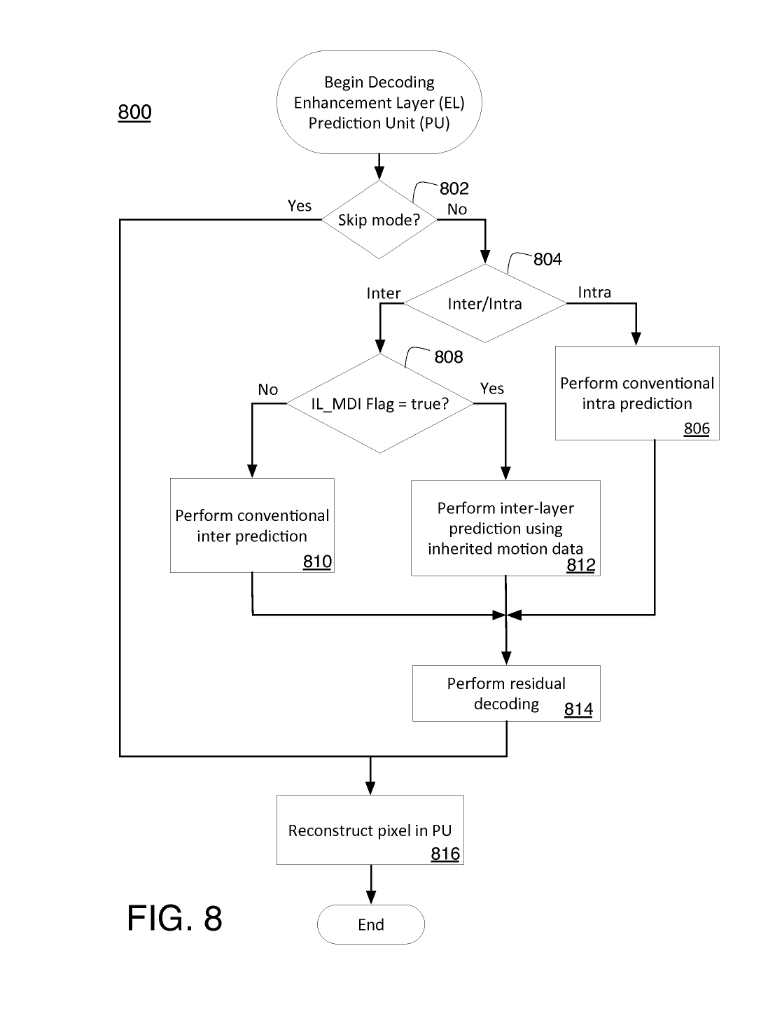

FIG. 8 illustrates a flow diagram of an example process 800, arranged in accordance with at least some implementations of the present disclosure. Process 800 may include one or more operations, functions or actions as illustrated by one or more of blocks 802, 804, 806, 808, 810, 812, 814, and 816 of FIG. 8. By way of non-limiting example, process 800 may form at least part of a scalable video coding process for a portion of an EL layer (e.g., a PU in this implementation) as undertaken by decoder system 300. Further, process 800 will also be described herein in reference to decoding an EL PU, although process 800 may be applied to any block as discussed herein, using the scalable video coding system 500 of FIG. 5 where SVC codec module 506 may instantiate decoder system 300, and to example bit stream 700 of FIG. 7.

Process 800 may begin at decision block 802, “Skip mode?”, where a determination may be made as to whether to undertake skip mode for a current EL PU being decoded in which the current PU would be decoded based on one or more previously decoded PUs. In various implementations, SVC codec 506 may undertake block 802 in response to the value of an indicator received in header portion 702 of bit stream 700. For example, if the indicator has a first value (e.g., one) then SVC codec 506 may determine to undertake skip mode for the current PU. If, on the other hand, the indicator has a second value (e.g., zero) then SVC codec 506 may determine to not undertake skip mode for the current PU.

If block 802 results in a negative determination then process 800 may proceed to decision block 804 “Inter/Intra” where a determination may be made regarding whether to perform intra or inter coding for the PU. If intra prediction is chosen then process 800 may proceed to block 806, “Perform conventional intra prediction”, where intra prediction may be performed using known intra prediction techniques. If inter prediction is chosen, then process 800 may proceed to decision block 808, “IL_MDI Flag=true?”, where a determination may be made as to whether to perform inter prediction using conventional techniques or whether inter prediction is to be performed using inherited motion data as described herein. In this example, block 808 may be undertaken based on the value of an Inter Layer Motion Data Inheritance (IL_MDI) indicator (e.g., flag 708) provided to the decoder in bit stream 700.

If the value of the indicator is negative (indicating that inter prediction using inherited motion data is not to be performed) then process 800 may proceed to block 810, “Perform conventional inter prediction”, where inter prediction may be performed using conventional inter prediction techniques. If, on the other hand, the value of the indicator is positive (e.g., the IL_MDI flag has a value of true) then process 800 may proceed to block 812, “Perform inter-layer prediction using inherited motion data”, where inter prediction may be performed using inherited motion data as described herein. Process 800 may then continue at block 814, “Perform residual decoding”, where residual decoding may be undertaken using known residual decoding techniques and the results of either block 810, 812 or 806. Finally, process 800 may end at block 816, “Reconstruct pixel in PU”, where known techniques may be used to reconstruct pixel value(s) for the PU.

While process 800 is described herein as a decoding process for an EL PU, the present disclosure is not limited to the performance of inter-layer prediction using inherited motion data at the PU level. Thus, in various implementations, process 800 may also be applied to a CU or to a TU or any block as discussed herein. Further, as noted previously, all inter-layer prediction using inherited motion data processes described herein including process 800 may be applied in the context of any combination of temporal, spatial, and/or quality scalable video coding.

FIG. 12 is an illustrative diagram of example video coding system 100 and video coding process 1200 in operation, arranged in accordance with at least some implementations of the present disclosure. In the illustrated implementation, process 1200 may include one or more operations, functions or actions as illustrated by one or more of actions 1201, 1202, 1203, 1204, 1205, 1206, 1207, 1208, 1209, 1210, 1211, 1212, 1213, and/or 1214. By way of non-limiting example, process 1200 will be described herein with reference to example video coding system 100 of FIG. 1.

In the illustrated implementation, video coding system 100 may include logic modules 1220, the like, and/or combinations thereof. For example, logic modules 1220, may include encoder 1230 (which may correspond to encoders 101 or 200, for example), which may include inter-layer motion data inheritance module 1250 and decoder 1240, which may include inter-layer motion data inheritance module 1260. Although video coding system 100, as shown in FIG. 12, may include one particular set of blocks or actions associated with particular modules, these blocks or actions may be associated with different modules than the particular module illustrated here. Although process 1200, as illustrated, is directed to encoding and decoding, the concepts and/or operations described may be applied to encoding and/or decoding separately, and, more generally, to video coding.

Process 1200 may begin at block 1201, “Determine Motion Data Associated with Reference Layer”, where motion data associated with a reference layer of video data may be determined For example, motion data 210 may be determined at BL encoder 202 such that the motion data may include, for example, one or more motion vectors, reference indices, and/or inter directions. As discussed, the reference layer may be a base layer or an enhancement layer that is at a lower level than the target enhancement layer (i.e., the enhancement layer to which the motion data will be transferred).

Process 1200 may continue from block 1201 to block 1202, “Determine Collocated Block of Reference Layer Associated with Block of Enhancement Layer”, where a collocated block of the reference layer associated with a (current) block of the enhancement layer may be determined. In some examples, a spatial scalability between the reference layer and the enhancement layer may be enabled and an enhancement layer picture size of the enhancement layer may be greater than a reference layer picture size of the reference layer and determining the collocated block may include using at least one of a top-left location, a center location, or a bottom right location of the block of the enhancement layer to determine the collocated block. In various examples, the collocated block may include at least one of an inter coded block or a hybrid block. Based on the collocated block, motion data associated with the collocated block may be determined or accessed as discussed herein.

Process 1200 may continue from block 1202 to block 1203, “Apply Scaling Factor to Motion Data”, where a scaling factor may be applied to the motion data. For example, the motion data may include at least one motion vector and the applying the scaling factor may include applying the scaling factor to the motion vector. For example, the motion vector may be associated with the collocated block. In various examples, the scaling factor may include a pre-defined scaling factor or an adaptive scaling factor or the like.

As discussed, in some examples (e.g., where no spatial scalability applies between the reference layer and the enhancement layer), process 1200 may skip block 1203. In any event, process 1200 may continue at block 1204, “Perform Motion Compensation”, where motion compensation for a block of an enhancement layer of the video data may be performed based at least in part on the motion data. For example, EL encoder 204 may perform motion compensation based at least in part on motion data 210.

Process 1200 may continue from block 1204 to block 1205, “Encode Bit Stream”, where a bit stream may be encoded based at least in part on the motion compensation. In some examples, the bit stream may be encoded with residual coding.

Process 1200 may continue from block 1205 to block 1206, “Transfer Bit Stream”, where the encoded bit stream may be transferred. As shown the encoded bitstream may be transferred to a decoder 1240. As discussed, encoder 1230 may be associated with and/or provided by a content provider system and decoder 1240 may be associated with a client system. Therefore, in various implementations, encoder 1230 and decoder 1240 may be implemented substantially independent of one another. In various examples, the bit stream may be transferred via the Internet, via a memory device, or the like. As will be appreciated, in some implementations, the bit stream may be transferred to multiple devices either serially or in parallel.

Process 1200 may continue from block 1206 or begin at block 1207, “Access Bit Stream to Determine Indicator Specifying whether or not to Perform Motion Compensation”, where a bit stream associated with video data may be accessed to determine an indicator that may specify whether to perform the motion compensation. The indicator may be accessed by decoder 300, for example. In some examples, the indicator may include a bit stream flag. As discussed above, if inter-layer prediction is not to be performed, then process 1200 may skip to block 1213.

If inter-layer prediction is to be performed, process 1200 may continue at block 1208 (if spatial scalability is enabled and a scaling factor has been provided via the bit stream), “Access Bit Stream to Determine Scaling Factor”, where a bit stream associated with the video data may be accessed to determine a scaling factor. As discussed, in some examples, a scaling factor may be encoded in a bit stream for decoding. For example, bit stream 700 may include one or more adaptive scaling factor(s) 710. If spatial scalability is enabled and a scaling factor has not been provided via the bit stream, a scaling factor may be determined as discussed herein at block 1211. In other examples, spatial scalability may not be enabled and no scaling factor may be needed (either via the bit stream or by determination at decoder 1240).

Process 1200 may continue at block 1209, “Determine Motion Data Associated with Reference Layer”, where motion data associated with a reference layer of video data may be determined For example, motion data 310 may be determined a BL decoder 302. As discussed, the motion data may include, for example, one or more motion vectors, reference indices, and/or inter directions. In general, the reference layer may be a base layer or an enhancement layer that is at a lower level than the target enhancement layer (i.e., the enhancement layer to which the motion data will be transferred).

Process 1200 may continue from block 1209 to block 1210, “Determine Collocated Block of Reference Layer Associated with Block of Enhancement Layer”, where a collocated block of the reference layer associated with a (current) block of the enhancement layer may be determined. As discussed, in some examples, a spatial scalability between the reference layer and the enhancement layer may be enabled and an enhancement layer picture size of the enhancement layer may be greater than a reference layer picture size of the reference layer and determining the collocated block may include using at least one of a top-left location, a center location, or a bottom right location of the block of the enhancement layer to determine the collocated block. In various examples, the collocated block may include at least one of an inter coded block or a hybrid block. Based on the collocated block, motion data associated with the collocated block may be determined or accessed as discussed herein.

If no scaling factor is to be applied, process 1200 may skip to block 1212. If a scaling factor is to be applied, process 1200 may continue from block 1210 to block 1211, “Apply Scaling Factor to Motion Data”, where a scaling factor may be applied to the motion data. For example, the motion data may include at least one motion vector and the applying the scaling factor may include applying the scaling factor to the motion vector. For example, the motion vector may be associated with the collocated block. In various examples, the scaling factor may include a pre-defined scaling factor implemented via decoder 1240 or an adaptive scaling factor received via a bit stream.

Process 1200 may continue at block 1212 (from block 1207, 1211, or 1209, for example), “Perform Motion Compensation”, where motion compensation for a block of an enhancement layer of the video data may be performed based at least in part on the motion data. For example, EL decoder 304 may perform motion compensation based at least in part on motion data 310.

Process 1200 may continue from block 1212 to block 1213, “Generate Enhancement Layer Output Frame”, where an enhancement layer output frame associated with the enhancement layer may be generated based at least in part on the motion compensation. For example, EL decoder 304 may generate EL output frame 306.

Process 1200 may continue from block 1213 to block 1214, “Transfer Output Frame for Presentment”, where the output frame may be transferred for presentment. For example, an output frame may be presented to a user via a display device.

While implementation of the example processes herein may include the undertaking of all blocks shown in the order illustrated, the present disclosure is not limited in this regard and, in various examples, implementation of the example processes herein may include the undertaking of only a subset of the blocks shown and/or in a different order than illustrated.

In addition, any one or more of the blocks discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of video systems 100, 200, and 300, SVC codec module 506, inter-layer motion data inheritance module 1250 or 1260, or the like.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

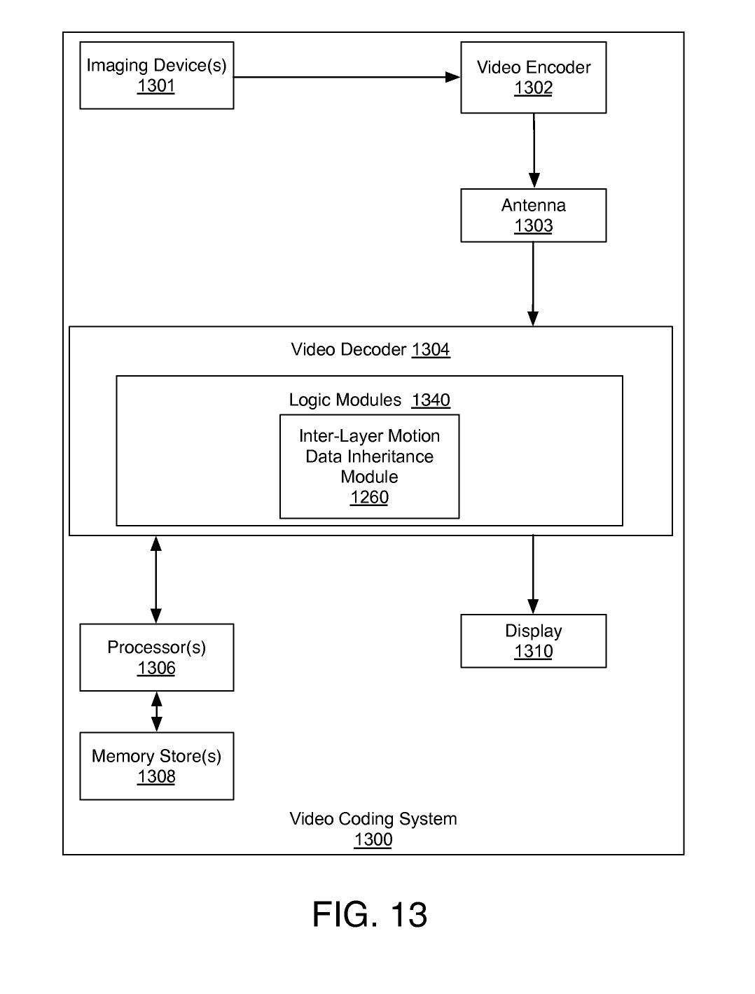

FIG. 13 is an illustrative diagram of an example video coding system 1300, arranged in accordance with at least some implementations of the present disclosure. In the illustrated implementation, video coding system 1300 may include imaging device(s) 1301, a video encoder 1302, an antenna 1303, a video decoder 504, one or more processors 1306, one or more memory stores 1308, a display 1310, and/or logic modules 1340. Logic modules 1340 may include inter-layer motion data inheritance module 1260, the like, and/or combinations thereof. In some examples, video encoder 1302 may implement one or more logic modules including an inter-layer motion data inheritance module such as inter-layer motion data inheritance module 1240, for example.

As illustrated, antenna 1303, video decoder 1304, processor 1306, memory store 1308, and/or display 1310 may be capable of communication with one another and/or communication with portions of logic modules 1340. Similarly, imaging device(s) 1301 and video encoder 1302 may be capable of communication with one another and/or communication with portions of logic modules 1340. Accordingly, video decoder 1304 may include all or portions of logic modules 1340, while video encoder 1302 may include similar logic modules. Although video coding system 1300, as shown in FIG. 13, may include one particular set of blocks or actions associated with particular modules, these blocks or actions may be associated with different modules than the particular module illustrated here.

In some examples, video coding system 1300 may include antenna 1303, video decoder 1304, the like, and/or combinations thereof. Antenna 1303 may be configured to receive an encoded bitstream of video data. Video decoder 1304 may be communicatively coupled to antenna 1303 and may be configured to decode the encoded bitstream. Video decoder 1304 may be configured to determine motion data associated with a reference layer of video data and perform motion compensation for a block of an enhancement layer of the video data based at least in part on the motion data, as discussed herein.

In other examples, video coding system 1300 may include display device 1310, one or more processors 1306, one or more memory stores 1308, inter-layer motion data inheritance module 1260, the like, and/or combinations thereof. Display device 1310 may be configured to present video data. Processors 1306 may be communicatively coupled to display 1310. Memory stores 1308 may be communicatively coupled to the one or more processors 1306. Inter-layer motion data inheritance module 1260 of video decoder 1304 (or video encoder 1302 in other examples) may be communicatively coupled to the one or more processors 1306 and may be configured to determine motion data associated with a reference layer of video data and perform motion compensation for a block of an enhancement layer of the video data based at least in part on the motion data, such that the presentment of image data via display device 1310 may be based at least in part on the motion compensation.

In various embodiments, inter-layer motion data inheritance module 1260 may be implemented in hardware, while software may implement other logic modules. For example, in some embodiments, inter-layer motion data inheritance module 1260 may be implemented by application-specific integrated circuit (ASIC) logic while other logic modules may be provided by software instructions executed by logic such as processors 1306. However, the present disclosure is not limited in this regard and inter-layer motion data inheritance module 1260 and/or other logic modules may be implemented by any combination of hardware, firmware and/or software. In addition, memory stores 1308 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 1308 may be implemented by cache memory.

In various examples, inter-layer motion data inheritance module 1260 may include a motion estimation module (e.g., motion estimation module 222) of a base layer encoder (e.g., BL encoder 202) and a motion compensation module (e.g., motion compensation module 226) of an enhancement layer encoder (e.g., EL encoder 204). Further, inter-layer motion data inheritance module 1260 may be implemented, at least in part, via hardware. Further, although not shown in FIG. 13, an inter-layer motion data inheritance module (e.g., inter-layer motion data inheritance module 1250) implemented via a video encoder (e.g., encoder 1230 or 1302) may include a motion estimation module (e.g., inter prediction module 316 having a motion estimation module) of a base layer decoder (e.g., BL decoder 302) and a motion compensation module (e.g., inter prediction module 324 having a motion compensation module) of an enhancement layer decoder (e.g., EL decoder 304). Further, an inter-layer motion data inheritance module implemented via a video encoder may be implemented, at least in part, via hardware.

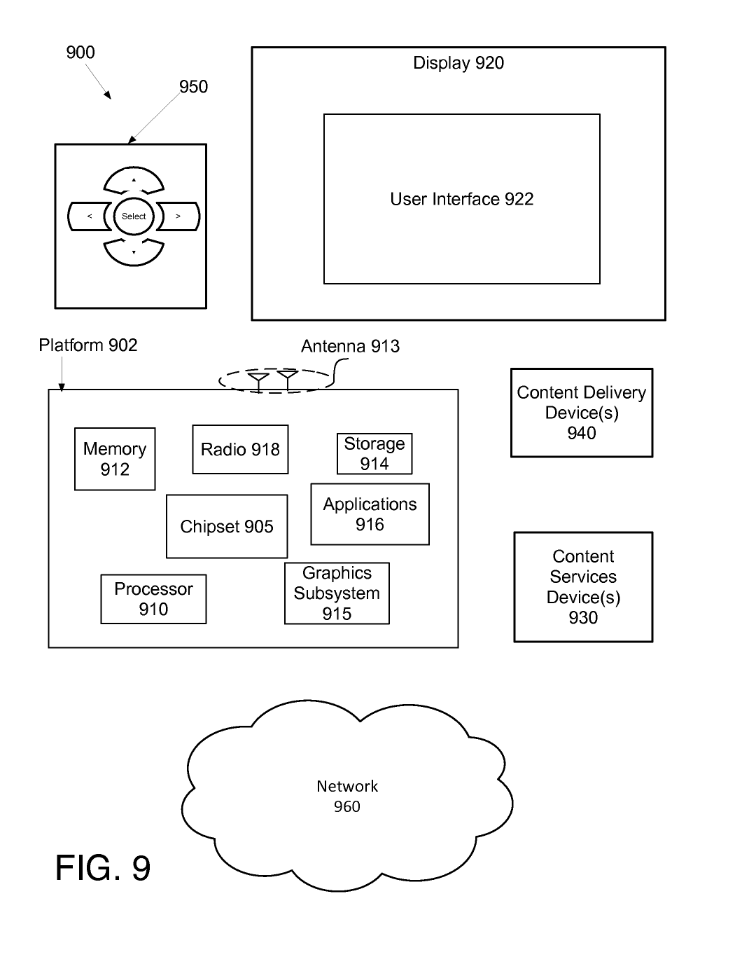

FIG. 9 illustrates an example system 900, arranged in accordance with at least some implementations of the present disclosure. In various implementations, system 900 may be a media system although system 900 is not limited to this context. For example, system 900 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 900 includes a platform 902 coupled to a display 920. Platform 902 may receive content from a content device such as content services device(s) 930 or content delivery device(s) 940 or other similar content sources. A navigation controller 950 including one or more navigation features may be used to interact with, for example, platform 902 and/or display 920. Each of these components is described in greater detail below.

In various implementations, platform 902 may include any combination of a chipset 905, processor 910, memory 912, antenna 913, storage 914, graphics subsystem 915, applications 916 and/or radio 918. Chipset 905 may provide intercommunication among processor 910, memory 912, storage 914, graphics subsystem 915, applications 916 and/or radio 918. For example, chipset 905 may include a storage adapter (not depicted) capable of providing intercommunication with storage 914.

Processor 910 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 910 may be dual-core processor(s), dual-core mobile processor(s), and so forth.

Memory 912 may be implemented as a volatile memory device such as, but not limited to, a Random Access Memory (RAM), Dynamic Random Access Memory (DRAM), or Static RAM (SRAM).

Storage 914 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 914 may include technology to increase the storage performance enhanced protection for valuable digital media when multiple hard drives are included, for example.

Graphics subsystem 915 may perform processing of images such as still or video for display. Graphics subsystem 915 may be a graphics processing unit (GPU) or a visual processing unit (VPU), for example. An analog or digital interface may be used to communicatively couple graphics subsystem 915 and display 920. For example, the interface may be any of a High-Definition Multimedia Interface, DisplayPort, wireless HDMI, and/or wireless HD compliant techniques. Graphics subsystem 915 may be integrated into processor 910 or chipset 905. In some implementations, graphics subsystem 915 may be a stand-alone device communicatively coupled to chipset 905.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In a further embodiments, the functions may be implemented in a consumer electronics device.

Radio 918 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 918 may operate in accordance with one or more applicable standards in any version.

In various implementations, display 920 may include any television type monitor or display. Display 920 may include, for example, a computer display screen, touch screen display, video monitor, television-like device, and/or a television. Display 920 may be digital and/or analog. In various implementations, display 920 may be a holographic display. Also, display 920 may be a transparent surface that may receive a visual projection. Such projections may convey various forms of information, images, and/or objects. For example, such projections may be a visual overlay for a mobile augmented reality (MAR) application. Under the control of one or more software applications 916, platform 902 may display user interface 922 on display 920.

In various implementations, content services device(s) 930 may be hosted by any national, international and/or independent service and thus accessible to platform 902 via the Internet, for example. Content services device(s) 930 may be coupled to platform 902 and/or to display 920. Platform 902 and/or content services device(s) 930 may be coupled to a network 960 to communicate (e.g., send and/or receive) media information to and from network 960. Content delivery device(s) 940 also may be coupled to platform 902 and/or to display 920.

In various implementations, content services device(s) 930 may include a cable television box, personal computer, network, telephone, Internet enabled devices or appliance capable of delivering digital information and/or content, and any other similar device capable of unidirectionally or bidirectionally communicating content between content providers and platform 902 and/display 920, via network 960 or directly. It will be appreciated that the content may be communicated unidirectionally and/or bidirectionally to and from any one of the components in system 900 and a content provider via network 960. Examples of content may include any media information including, for example, video, music, medical and gaming information, and so forth.

Content services device(s) 930 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 902 may receive control signals from navigation controller 950 having one or more navigation features. The navigation features of controller 950 may be used to interact with user interface 922, for example. In various embodiments, navigation controller 950 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 950 may be replicated on a display (e.g., display 920) by movements of a pointer, cursor, focus ring, or other visual indicators displayed on the display. For example, under the control of software applications 916, the navigation features located on navigation controller 950 may be mapped to virtual navigation features displayed on user interface 922, for example. In various embodiments, controller 950 may not be a separate component but may be integrated into platform 902 and/or display 920. The present disclosure, however, is not limited to the elements or in the context shown or described herein.

In various implementations, drivers (not shown) may include technology to enable users to instantly turn on and off platform 902 like a television with the touch of a button after initial boot-up, when enabled, for example. Program logic may allow platform 902 to stream content to media adaptors or other content services device(s) 930 or content delivery device(s) 940 even when the platform is turned “off.” In addition, chipset 905 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 900 may be integrated. For example, platform 902 and content services device(s) 930 may be integrated, or platform 902 and content delivery device(s) 940 may be integrated, or platform 902, content services device(s) 930, and content delivery device(s) 940 may be integrated, for example. In various embodiments, platform 902 and display 920 may be an integrated unit. Display 920 and content service device(s) 930 may be integrated, or display 920 and content delivery device(s) 940 may be integrated, for example. These examples are not meant to limit the present disclosure.

In various embodiments, system 900 may be implemented as a wireless system, a wired system, or a combination of both. When implemented as a wireless system, system 900 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 900 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 902 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 9.

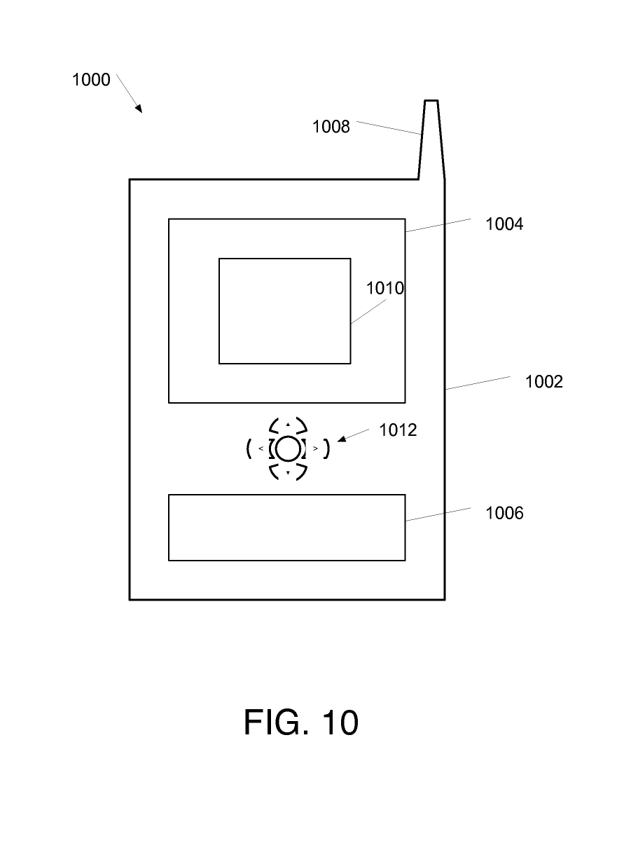

As described above, system 900 may be embodied in varying physical styles or form factors. FIG. 10 illustrates implementations of a small form factor device 1000 in which system 1000 may be embodied, arranged in accordance with at least some implementations of the present disclosure. In various embodiments, for example, device 1000 may be implemented as a mobile computing device a having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 10, device 1000 may include a housing 1002, a display 1004, an input/output (I/O) device 1006, and an antenna 1008. Device 1000 also may include navigation features 1012. Display 1004 may include any suitable display unit for displaying information appropriate for a mobile computing device. I/O device 1006 may include any suitable I/O device for entering information into a mobile computing device. Examples for I/O device 1006 may include an alphanumeric keyboard, a numeric keypad, a touch pad, input keys, buttons, switches, rocker switches, microphones, speakers, voice recognition device and software, and so forth. Information also may be entered into device 1000 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer-implemented method for performing scalable video coding may include determining motion data associated with a reference layer of video data and performing motion compensation for a block of an enhancement layer of the video data based at least in part on the motion data.

In another example, a computer-implemented method for performing scalable video coding may further include determining a collocated block of the reference layer associated with the block of the enhancement layer such that a spatial scalability between the reference layer and the enhancement layer is enabled and an enhancement layer picture size is greater than a reference layer picture size. Determining the collocated block may include using at least one of a top-left location, a center location, or a bottom right location of the block of the enhancement layer to determine the collocated block. The motion data may include motion data associated with the collocated block of the reference layer. The collocated block may include at least one of an inter coded block or a hybrid block. The computer-implemented method may further include applying a scaling factor to at least one motion vector of the motion data prior to performing the motion compensation such that the scaling factor includes at least one of a pre-defined scaling factor or an adaptive scaling factor, encoding a bit stream based at least in part on the motion compensation such that the bit stream is encoded with residual coding, accessing a bit stream associated with the video data to determine an indicator such that the indicator specifies whether to perform the motion compensation and such that the indicator comprises a bit stream flag, accessing the bit stream associated with the video data to determine the scaling factor, and generating an enhancement layer output frame associated with the enhancement layer based at least in part on the motion compensation. The motion data may include at least one of a motion vector, a reference index, or an inter direction. The reference layer may include at least one of a base layer or a second enhancement layer such that the enhancement layer is a higher layer than the second enhancement layer. At least one of a quality scalability, a temporal scalability, or a bit depth scalability between the reference layer and the enhancement layer may be enabled. The motion compensation may be performed for at least one of a slice, a picture, or a layer level. The block may include at least one of a prediction unit, a prediction block, transform unit, or a coding unit. The at least one motion vector may have a granularity comprising at least one of 4×4, 8×8, or 16×16 such that the block of the enhancement layer is a 16×16 prediction unit. The reference layer may include a base layer and the enhancement layer may include a level 1 enhancement layer. Performing the motion compensation may include performing motion compensation at an enhancement layer decoder. The enhancement layer decoder may be implemented, at least in part, via hardware. Performing the motion compensation may include performing motion compensation at an enhancement layer encoder.

In other examples, a system for video coding on a computer may include a display device, one or more processors, one or more memory stores, an inter-layer motion data inheritance module, the like, and/or combinations thereof. The display device may be configured to present video data. The one or more processors may be communicatively coupled to the display device. The one or more memory stores may be communicatively coupled to the one or more processors. The inter-layer motion data inheritance module may be communicatively coupled to the one or more processors and configured to determine motion data associated with a reference layer of video data and perform motion compensation for a block of an enhancement layer of the video data based at least in part on the motion data. The presentment of image data via the display device may be based at least in part on the motion compensation.

In a further example system, the inter-layer motion data inheritance module may be configured to determine a collocated block of the reference layer associated with the block of the enhancement layer, apply a scaling factor to at least one motion vector of the motion data prior to performing the motion compensation such that the scaling factor comprises at least one of a pre-defined scaling factor or an adaptive scaling factor, encode a bit stream based at least in part on the motion compensation such that the bit stream is encoded with residual coding, access a bit stream associated with the video data to determine an indicator such that the indicator specifies whether to perform the motion compensation and the indicator includes a bit stream flag, access the bit stream associated with the video data to determine a scaling factor, and generate an enhancement layer output frame associated with the enhancement layer based at least in part on the motion compensation. A spatial scalability between the reference layer and the enhancement layer may be enabled and an enhancement layer picture size may be greater than a reference layer picture size. Determining the collocated block may include using at least one of a top-left location, a center location, or a bottom right location of the block of the enhancement layer to determine the collocated block. The motion data may include motion data associated with the collocated block of the reference layer. The collocated block comprises at least one of an inter coded block or a hybrid block. The motion data may include at least one of a motion vector, a reference index, or an inter direction. The reference layer may include at least one of a base layer or a second enhancement layer such that the enhancement layer is a higher layer than the second enhancement layer. At least one of a quality scalability, a temporal scalability, or a bit depth scalability between the reference layer and the enhancement layer may be enabled. The motion compensation may be performed for at least one of a slice, a picture, or a layer level. The block may include at least one of a prediction unit, a prediction block, transform unit, or a coding unit. The at least one motion vector may have a granularity comprising at least one of 4×4, 8×8, or 16×16 such that the block of the enhancement layer is a 16×16 prediction unit. The reference layer may include a base layer and the enhancement layer may include a level 1 enhancement layer. The inter-layer motion data inheritance module may include a motion estimation module of a base layer encoder and a motion compensation module of an enhancement layer encoder. The inter-layer motion data inheritance module may implemented, at least in part, via hardware. The inter-layer motion data inheritance module may include a motion estimation module of a base layer decoder and a motion compensation module of an enhancement layer decoder.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

1-25. (canceled)

26. An apparatus, comprising:
circuitry configured to access reference motion data associated with at least one reference layer picture, the reference layer picture comprising one of a plurality of pictures of a first layer of multi-layer video content, the decoder circuitry to perform inter-layer prediction for a current picture based at least in part on the reference motion data, wherein the current picture comprises one of a plurality of pictures of a second layer of the multi-layer video content, wherein the second layer is different than the first layer.

27. The apparatus of claim 26, wherein the circuitry is configured to perform inter-layer prediction for the current picture in response to a bitstream flag conveyed to the decoder circuitry in a bitstream syntax associated with the multi-layer video content.

28. The apparatus of claim 26, wherein the reference motion data comprises at least motion vectors, and reference indices.

29. The apparatus of claim 26, further comprising memory to store at least one of the reference layer picture or the reference motion data.

30. The apparatus of claim 26, wherein the circuitry comprises at least one of video decoder circuitry or video encoder circuitry.

31. The apparatus of claim 26, the circuitry further configured to determine a collocated block of the reference layer picture associated with a block of the second layer.

32. The apparatus of claim 26, wherein the first layer comprises an enhancement layer, and wherein the second layer comprises a base layer.

33. The apparatus of claim 26, the circuitry further configured to apply a scaling factor to at least one motion vector of the reference motion data prior, wherein the scaling factor comprises at least one of a pre-defined scaling factor or an adaptive scaling factor.

34. The apparatus of claim 26, the circuitry further configured to perform motion compensation based at least in part on the performed inter-layer prediction.

35. A method comprising:
accessing reference motion data associated with at least one reference layer picture, the reference layer picture comprising one of a plurality of pictures of a first layer of multi-layer video content; and
performing inter-layer prediction for a current picture based at least in part on the reference motion data, wherein the current picture comprises one of a plurality of pictures of a second layer of the multi-layer video content, wherein the second layer is different than the first layer.

36. The method of claim 35, wherein performing inter-layer prediction for the current picture comprises performing inter-layer prediction for the current picture in response to a bitstream flag conveyed in a bitstream syntax associated with the multi-layer video content.

37. The method of claim 35, wherein the reference motion data comprises at least motion vectors, and reference indices.

38. The method of claim 35, further comprising storing at least one of the reference layer picture or the reference motion data.

39. The method of claim 35, further comprising determining a collocated block of the reference layer picture associated with a block of the second layer.

40. The method of claim 35, wherein the first layer comprises an enhancement layer, and wherein the second layer comprises a base layer.

41. The method of claim 35, further comprising applying a scaling factor to at least one motion vector of the reference motion data prior, wherein the scaling factor comprises at least one of a pre-defined scaling factor or an adaptive scaling factor.

42. The method of claim 35, the method further comprising performing motion compensation based at least in part on the performed inter-layer prediction.

43. At least one machine-readable medium comprising a plurality of instructions that in response to being executed on a computing device, cause the computing device to:
access reference motion data associated with at least one reference layer picture, the reference layer picture comprising one of a plurality of pictures of a first layer of multi-layer video content; and
perform inter-layer prediction for a current picture based at least in part on the reference motion data, wherein the current picture comprises one of a plurality of pictures of a second layer of the multi-layer video content, wherein the second layer is different than the first layer.

44. The at least one machine-readable medium of claim 43, wherein performing inter-layer prediction for the current picture comprises performing inter-layer prediction for the current picture in response to a bitstream flag conveyed in a bitstream syntax associated with the multi-layer video content.

45. The at least one machine-readable medium of claim 43, wherein the reference motion data comprises at least motion vectors, and reference indices.

46. The at least one machine-readable medium of claim 43, further comprising applying a scaling factor to at least one motion vector of the reference motion data prior, wherein the scaling factor comprises at least one of a pre-defined scaling factor or an adaptive scaling factor.

47. The at least one machine-readable medium of claim 43, the method further comprising performing motion compensation based at least in part on the performed inter-layer prediction.
